(19) United States
(12) Patent Application Publication
(10) Pub. No.: US 2002/0024188 A1
(43) Pub. Date: Feb. 28, 2002

(54) Twist vehicle

(76) Inventor: Hong-jiun Gu, Taipei (TW)

Correspondence Address: Raymond Y. Chan, 1050 Oakdale Lane, Arcadia, CA, 91006, US

(21) Appl. No.: 09/792,865

(22) Filed: Feb. 23, 2001

(30) Foreign Application Priority Data
Feb. 23, 2000 (TW) 89202903

(51) Int. Cl. B62B 13/08; B62B 11/00

(52) U.S. Cl. 280/16; 280/21.1; 280/87.01

(57) ABSTRACT

The present invention relates to a twist vehicle which includes three interchangeable driving devices, so that by changing the driving devices, the twist vehicle is capable of moving on different environments. The twist vehicle includes a changeable driving device connected to a twisting device, which is then connected to a steering device by a transmission device, so that when a clockwise and an anti-clockwise movements are imparted to the steering device, the twisting device turns correspondingly as a result, causing the twist vehicle to move on a flat ground, a snowy ground or water, depending on the selectively prearranged driving device of the twist vehicle.

### BACKGROUND OF THE PRESENT INVENTION

1. Field of Invention

The present invention relates to a vehicle, and more particularly to a twist vehicle having a changeable driving device connected to a twisting device, which is connected to a steering device by a transmission device, so that when a clockwise and an anti-clockwise movements are imparted to the steering device, the twisting device turns correspondingly as a result, causing the twist vehicle to move on a flat ground, a snowy ground or water, depending on the prearranged driving device of the twist vehicle.

2. Description of Related Arts

Usually, conventional manual vehicles can only be adapted to travel in a particular environment. In case of journey that requires conventional manual vehicles to travel in many environmental situations, their riders often feel inconvenient, disappointing and even frustrating.

### SUMMARY OF THE PRESENT INVENTION

A main object of the present invention is to provide a twist vehicle for multiple purposes which include, exclusively, twisting on a flat ground, sliding on a snowy ground and gliding on water.

Another object of the present invention is to provide a twist vehicle which comprises three interchangeable driving devices—namely driving device for snowy ground, driving device for land and driving device for water, driving the twist vehicle to move on snowy ground, typical flat ground and water respectively.

Another object of the present invention is to provide a twist vehicle which comprises a vehicle frame, selectively one of the three changeable driving devices connected to a twisting device, which is further connected to a steering device by a transmission device, so that when a clockwise and an anti-clockwise movements are imparted to the steering device, the twisting device turns correspondingly as a result, causing the twist vehicle to move on a flat ground, a snowy ground or water, depending on the prearranged driving device of the twist vehicle.

Another object of the present invention is to provide a twist vehicle, wherein the twisting unit comprises a fastening device to fasten the driving device for snowy ground.

Another object of the present invention is to provide a twist vehicle, wherein the twisting unit has two supporting holes for supporting the driving device for land and the driving device for water.

Another object of the present invention is to provide a twist vehicle, wherein the twisting unit is capable to rotate freely with respect to the vehicle frame, such that the twist vehicle is capable to move forwardly and backwardly on a flat land.

Another object of the present invention is to provide a twist vehicle, wherein the vehicle frame comprises a pair of auxiliary wheels for enhancing the land moving ability of the twist vehicle and supporting the twist vehicle.

Another object of the present invention is to provide a twist vehicle, wherein the shape of the vehicle frame is adapted to be floatable on water.

Another object of the present invention is to provide a twist vehicle which further comprises a braking system attached to the vehicle frame to decelerate the twist vehicle whenever necessary.

To enhance further understanding of the above objectives and the underlying technological methods of the present invention, the brief description of the drawings below is followed by a detailed description of a preferred embodiment.

### BRIEF DESCRIPTION OF THE DRAWINGS

FIG. 1 is an isometric view of a twist vehicle according to a first preferred embodiment of the present invention.

FIG. 2 is an isometric view of a driving device of the twist vehicle for snowy ground, according to the above first preferred embodiment of the present invention.

FIG. 3 is an isometric view of the driving device of the twist vehicle for land, according to a second preferred embodiment of the present invention.

FIG. 4 is a side view of the twisting vehicle incorporated with the above driving device for land, according to the above second preferred embodiment of the present invention.

FIG. 5 is a side view of the twisting vehicle incorporated with the water driving device, according to a third preferred embodiment of the present invention.

FIG. 6 is a side view of the twist vehicle incorporated with a braking system, according to the above first and second embodiments of the present invention.

### DETAILED DESCRIPTION OF THE PREFERRED EMBODIMENT

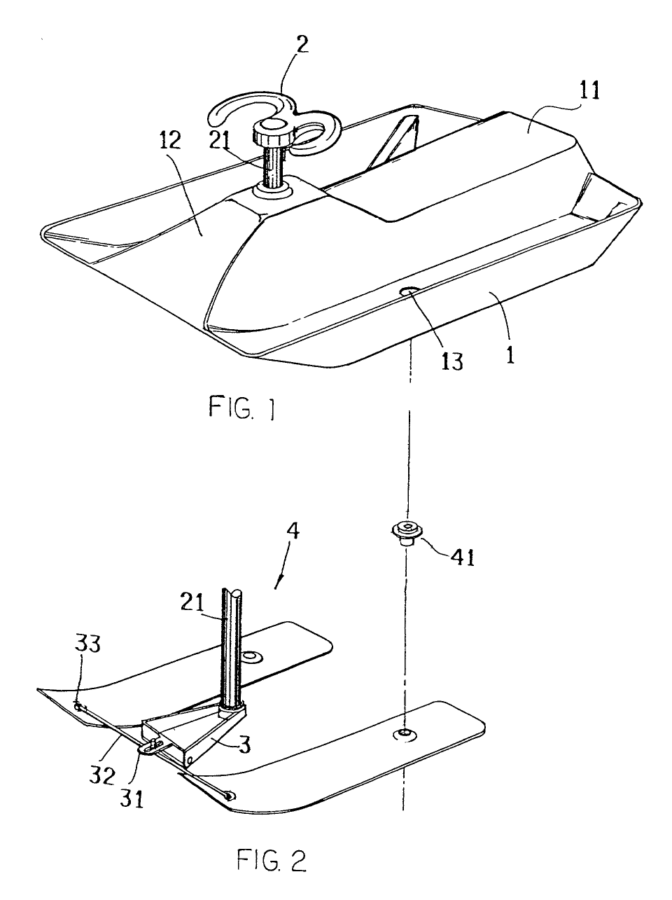

Referring to FIGS. 1-2 of the drawings, a twist vehicle for multiple purposes according to a first preferred embodiment is illustrated. The twist vehicle comprises a vehicle frame 1 having a driving cavity 12 provided at the front portion, a steering device 2, a twisting device 3, a transmission device 21, and a driving device. The transmission device 21 has one portion perpendicularly connected to the steering device 2 which is positioned above the driving cavity 12, and has another portion perpendicularly connected to the twisting device 3 which is positioned below the vehicle frame 1. The transmission device 21 is rotationally connected to the vehicle frame 1. The driving device comprises a pair of skis 4, a pair of connectors 41, a connecting rod 32 and a pair of live joints 33 positioned at the front portion of the pair of skis respectively. The twisting device 3 comprises a fastening device 31 wherein the fastening device 31 of the twisting device 3 is connected to the central portion of the connecting rod 32; while the two end portions of the connecting rob 32 are pivotally connected to the two live joints 33 on the two skis 4 respectively.

The vehicle frame 1 has a pair of jointing holes 13 provided at the rear portion, wherein the pair of skis 4 are pivotally connected to the vehicle frame 1 through the jointing holes 13 by the pair of connectors 41, for the rear portions of the pair of skis 4 to be able to twist about the two jointing holes 13 respectively.

When a clockwise and an anti-clockwise movements are subsequently imparted to the steering device 2, so as to the transmission device 21, the twisting device 3 is driven to turn correspondingly as a result. Since the twisting device 3 is fastened to the central portion of the connecting rod 32 which has two end portions pivotally jointed to the pair of skis 4 by the pair of live joints 33, the pair of skis 4 are then therefore driven to rotate correspondingly, causing the twist vehicle to slide forwardly on a snowy ground or on a flat ground of comparable hardness and coefficient of friction.

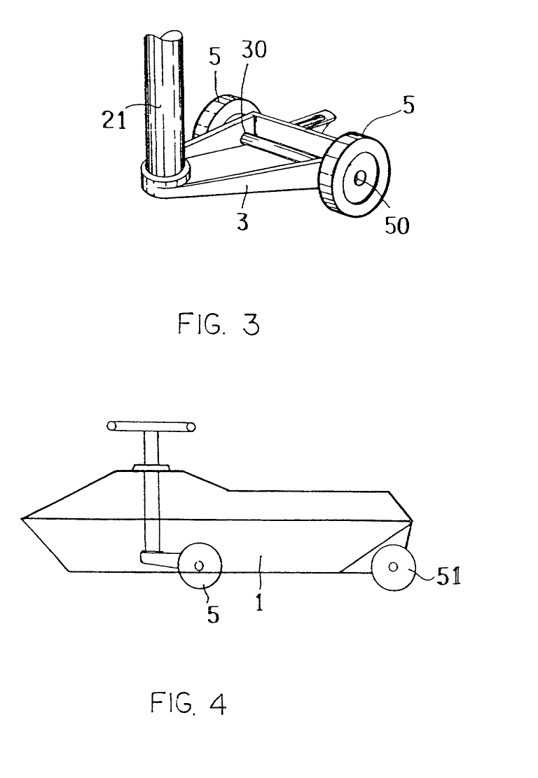

Referring to FIG. 3 of the drawings, a second embodiment of the twist vehicle illustrates a first alternative mode of the first embodiment of the present invention. According to the second embodiment, the twist vehicle is adapted for driving on a ground. According to the second embodiment, the twisting device 3 further has a pair of same-axis supporting holes 30 spacedly apart from each other and spacedly apart from the front portion, which is connected to the transmission device 21 of the twist vehicle, of the twisting unit 3, while the driving device comprises a pair of wheels 5 and a wheel axle 50. The wheel axle 50 is arranged to pass through the pair of supporting holes 30 and connect the pair of wheels 5 such that the pair of wheels 5 are capable of rotating about the wheel axis 50. When a clockwise and an anti-clockwise movements are subsequently imparted to the steering device 2, so as to the transmission device 21, the twisting device 3 and then the pair of wheels 50 are driven to turn correspondingly as a result, causing the twist vehicle to move forwardly.

Referring to FIG. 4 of the drawings, the vehicle frame 1 further comprises a pair of auxiliary wheels 51 attached at the two sides of the rear portion of the vehicle frame 1 so as to support the twist vehicle when it is moving on a ground.

Referring to FIG. 3 of the drawings, when the steering device 2 is rotated by 180°, causing the original front portion of the twisting device 3 to become the rear portion with respect to the vehicle frame, continuous clockwise and anti-clockwise movements of the steering device 2 will cause the twist vehicle to move backwardly.

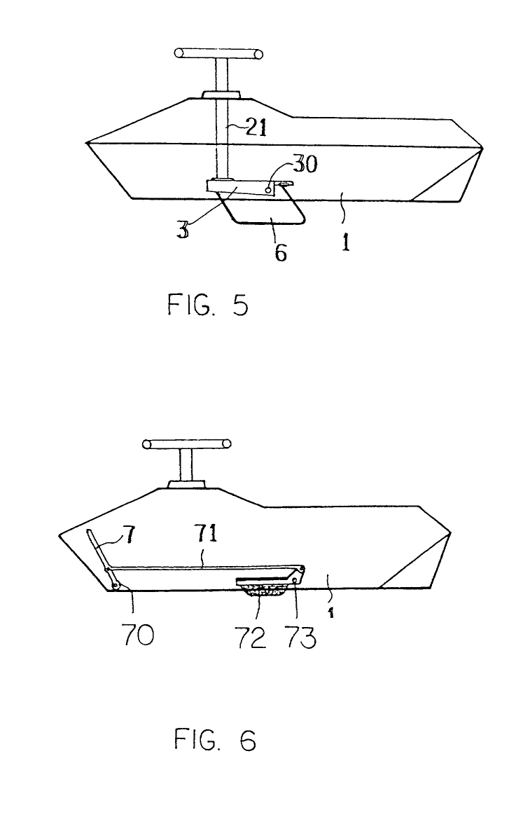

Referring to FIG. 5 of the drawings, a third embodiment of the twist vehicle illustrates a second alternative mode of the first embodiment of the present invention. According to the third embodiment, the twist vehicle is adapted to glide on water. According to the third embodiment, the twisting device 3 has, as in the case of second embodiment, a pair of same-axis supporting holes 30 space apart from each other and from the front portion. The driving device comprises an oar 6 and a locking rod 61 wherein the oar 6 is connected to the pair of supporting holes 30 of the twisting device 3 by the locking rod 61. The shape of the vehicle frame 1 of the twist vehicle is adapted to be floatable on water. When clockwise and anticlockwise movements are subsequently imparted to the steering device 2, so as to the transmission device 21, the twisting unit 2 and therefore the oar 6 is driven to row correspondingly as a result, inducing a pressure difference between the two sides of the oar 6, and therefore driving the twist vehicle to glide on water.

Referring to FIG. 6 of the drawings, it is worth to mention that the twist vehicle in the first and the second embodiments can be equipped with a braking system attached to the vehicle frame 1. The braking system comprises a braking paddle 7, a pivot 70, an auxiliary rod 71, a braking unit 72, and a pivotal rod 73 and a restoring member. The braking paddle 7 is pivotally connected to vehicle frame 1 about the pivot 70 and pivotally connected to the auxiliary rod 71 which is then pivotally connected to the braking unit 72 by a pivotal rod 73. The restoring member is connected to the pivotal rod. When the rider applies a downward force to the paddle 7, such as stepping on the braking paddle 7, the braking unit 72 is forced to bias against the ground in which the twist vehicle is moving, so as to decelerate the twist vehicle whenever necessary. When the downward force is relieved, the restoring member can rebound the braking paddle 7 to its original position.

Equally remarkable is that the twist vehicle is capable of interchanging the three driving devices to adapt to different driving environments.

What is claimed is:

1. A twist vehicle, comprising:
a vehicle frame having a driving cavity provided at front portion of said vehicle frame and two spacedly apart jointing holes provided at rear bottom portion of said vehicle frame;
a steering device positioned above said driving cavity;
a twisting device positioned below said vehicle frame;
a transmission device, which is rotationally connected with said vehicle frame, having one portion connecting with said steering device and another portion connecting said twisting device; and
a changeable driving device, which drives said twist vehicle to move, connecting with said twisting device, so that when a clockwise and an anti-clockwise forces are subsequently applied to said steering device, said twisting device turns correspondingly as a result, causing said twist vehicle to move.

2. A twist vehicle, as recited in claim 1, wherein said driving device comprises a pair of skis having front portions pivotally connected to said twisting device and rear portions rotatably connected to rear portion of said vehicle frame through two jointing holes provided at said rear portions of said vehicle frame respectively.

3. A twist vehicle, as recited in claim 2, wherein said driving device further comprises a connecting rod having two end portions pivotally connected to said front portion of one of said pair of skis and said front portion of another one of said pair of skis respectively, such that when said steering device turns subsequently in clockwise and anti-clockwise direction, said transmission device also turns correspondingly and said twisting device also turns correspondingly as a result.

4. A twist vehicle, as recited in claim 3, wherein said twisting device further comprises a fastening device integrally extended from front portion of said twisting device for connecting a central portion of said connecting rod.

5. A twist vehicle, as recited in claim 4, wherein said driving device further comprises a pair of connectors connecting said rear portions of said pair of skis with said vehicle frame by passing through said two jointing holes respectively.

6. A twist vehicle, as recited in claim 2, wherein said vehicle frame further comprises a braking system which comprises a braking paddle, a pivot, an auxiliary rod, a braking unit, and a pivotal rod, wherein said braking paddle is pivotally connected to said vehicle frame about said pivot and pivotally connected to said auxiliary rod which is then pivotally connected to said braking unit by said pivotal rod.

7. A twist vehicle, as recited in claim 5, wherein said vehicle frame further comprises a braking system which comprises a braking paddle, a pivot, an auxiliary rod, a braking unit, and a pivotal rod, wherein said braking paddle is pivotally connected to said vehicle frame about said pivot and pivotally connected to said auxiliary rod which is then pivotally connected to said braking unit by said pivotal rod.

8. A twist vehicle, as recited in claim 5, wherein said transmission device comprises a shaft having one end portion connected to said steering device and another end portion connected to said twisting device, such that when said steering device subsequently turns in clockwise and anti-clockwise directions, said transmission device and therefore said twisting device turns in said same manner as a result.

9. A twist vehicle, as recited in claim 5, wherein said transmission device comprises a shaft having one end portion connected to said steering device and another end portion connected to said twisting device, such that when said steering device subsequently turns in clockwise and anti-clockwise directions, said transmission device and therefore said twisting device turns in said same manner as a result.

10. A twist vehicle, as recited in claim 1, wherein said driving device comprises a pair of wheels rotatably connected to the twisting device in such a manner that said two wheels are space apart from each other and space apart from said portion of said twisting device which is connected to said transmission device.

11. A twist vehicle, as recited in claim 10, wherein said driving device further comprises a wheel axle having two ends for securely attaching said two wheels thereto respectively wherein said wheel axle is rotatably passing through a pair of same-axis supporting holes spacedly provided on said twisting device in such a manner that said two wheels are capable of freely rotating with respect to said twisting device.

12. A twist vehicle, as recited in claim 11, wherein said vehicle frame further comprises a pair of auxiliary wheels detachably and rotatably attached at two sides of rear portion of said vehicle frame, so as to enhance movement of said twist vehicle on a flat ground.

13. A twist vehicle, as recited in claim 10, wherein said vehicle frame further comprises a braking system which comprises a braking paddle, a pivot, an auxiliary rod, a braking unit, and a pivotal rod, wherein said braking paddle is pivotally connected to said vehicle frame about said pivot and pivotally connected to said auxiliary rod which is then pivotally connected to said braking unit by said pivotal rod.

14. A twist vehicle, as recited in claim 11, wherein said vehicle frame further comprises a braking system which comprises a braking paddle, a pivot, an auxiliary rod, a braking unit, and a pivotal rod, wherein said braking paddle is pivotally connected to said vehicle frame about said pivot and pivotally connected to said auxiliary rod which is then pivotally connected to said braking unit by said pivotal rod.

15. A twist vehicle, as recited in claim 12, wherein said vehicle frame further comprises a braking system which comprises a braking paddle, a pivot, an auxiliary rod, a braking unit, and a pivotal rod, wherein said braking paddle is pivotally connected to said vehicle frame about said pivot and pivotally connected to said auxiliary rod which is then pivotally connected to said braking unit by said pivotal rod.

16. A twist vehicle, as recited in claim 10, wherein said transmission device comprises a shaft having one end portion connected to said steering device and another end portion connected to said twisting device, such that when said steering device subsequently turns in clockwise and anti-clockwise directions, said transmission device and therefore said twisting device turns in said same manner as a result.

17. A twist vehicle, as recited in claim 11, wherein said transmission device comprises a shaft having one end portion connected to said steering device and another end portion connected to said twisting device, such that when said steering device subsequently turns in clockwise and anti-clockwise directions, said transmission device and therefore said twisting device turns in said same manner as a result.

18. A twist vehicle, as recited in claim 12, wherein said transmission device comprises a shaft having one end portion connected to said steering device and another end portion connected to said twisting device, such that when said steering device subsequently turns in clockwise and anti-clockwise directions, said transmission device and therefore said twisting device turns in said same manner as a result.

19. A twist vehicle, as recited in claim 1, wherein said driving device comprises an oar wherein said oar is perpendicularly and downwardly connected to bottom surface of said twisting device, so as to impel said twist vehicle to glide on water amid a series of clockwise and anti-clockwise movements of said oar which are generated by clockwise and anti-clockwise movements from said steering device.

20. A twist vehicle, as recited in claim 19, wherein said twisting device further comprises a locking rod and has a pair of same-axis supporting holes spacedly apart from each other and from front portion of said twisting device, such that said locking rod is capable of locking said oar to said twisting device by fitly passing through said pair of same-axis supporting holes and penetrating through said oar.
